(19) United States
(12) Patent Application Publication
(10) Pub. No.: US 2006/0289234 A1
(43) Pub. Date: Dec. 28, 2006

(54) Tool kit (hooks)

(76) Inventor: John Smith, Chicago, IL (US)

Correspondence Address: JOHN SMITH, 3305 N. OSAGE, CHICAGO, IL, 60634, US

(21) Appl. No.: 11/182,041

(22) Filed: Dec. 29, 2005

Related U.S. Application Data
(60) Provisional application No. 60/675,840, filed on Apr. 29, 2005.

(51) Int. Cl. E06C 5/32

(52) U.S. Cl. 182/129

(57) ABSTRACT

The Great Grab Bar is connected to a regular top of a step ladder and when fastened it actually becomes part of the step ladder. The purpose of my invention The Great Grab Bar is that it s a very safe tool and saves time of going up and down a regular step ladder. The hooks at each end of the Great Grab Bar hold an enormos amount of weight.

I claim that the Great Grab Bar is a metal bar held across a regular standard step ladder which opens and closes. On the top of the regular standard step ladder is where the Great Grab Bar sits connected through two pre drilled holes on it and fastened at the bottom of the top of the step ladder. It is fastened by two centered threaded bolts four washers two lock nuts and tightened at the bottom of the top of the step ladder.

When the Great Grab Bar is ready to be mounted it goes through the pre drilled holes from the top with two top washers on the centered threaded bolts. It is then connected at the bottom of the top of the step ladder with two washers. It is tightened with two lock nuts at the bottom.

Once attached and tightened the Great Grab Bar with its two hooks one on left side and one on the right side are ready to do its job for the project.

The Great Grab Bars job is to hold objects at each end such as buckets or anything which will hook on its end within reason.

The Great Grab Bar is made out of metal and its perfect for industrial commercial and residential work. Once stationary the Great Grab Bar becomes part of the step ladder and you can move the step ladder with the objects on it because their held safe. Its perfectly safe and saves time of running up and down the step ladder with tools.

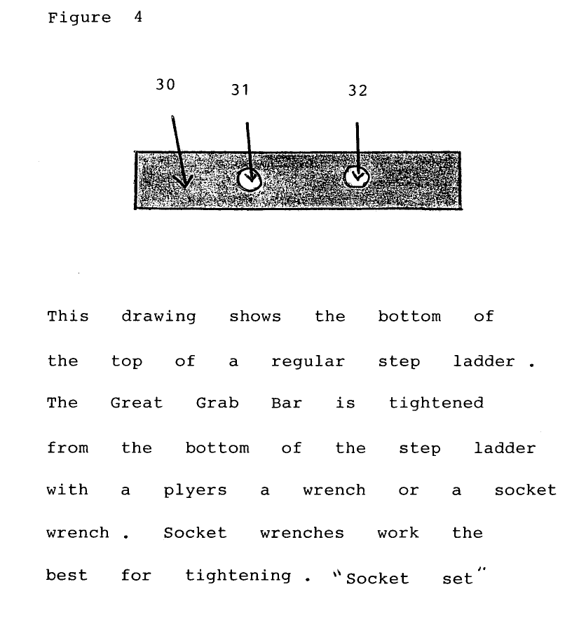

The Great Grab Bar can also be hooked up with an expansion tray box in front of it held by two wires. The expansion tray box is made for light objects such as light bulbs screws and light things of that nature. FIGS. 3 4 5 6 and 7 do not show the complete embodiment of the Great Grab Bar.

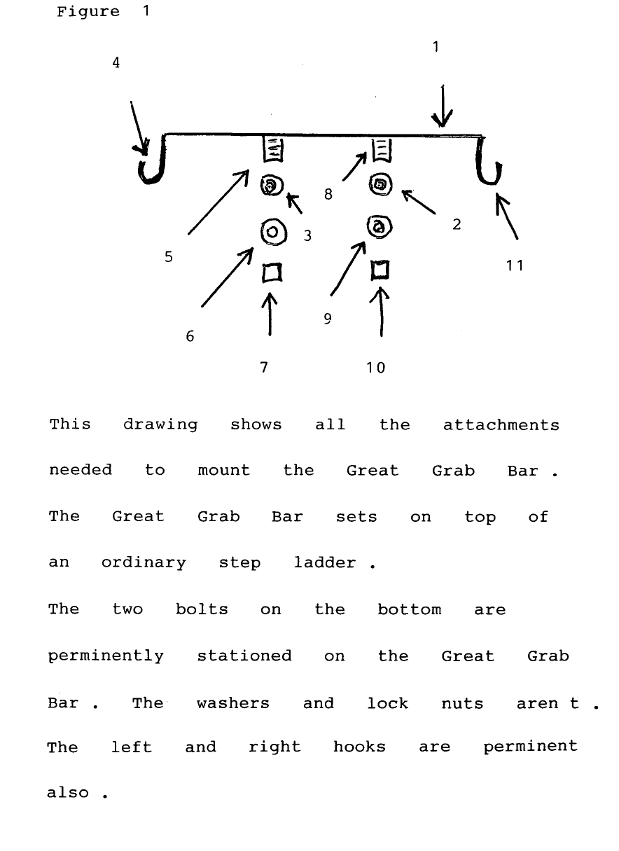

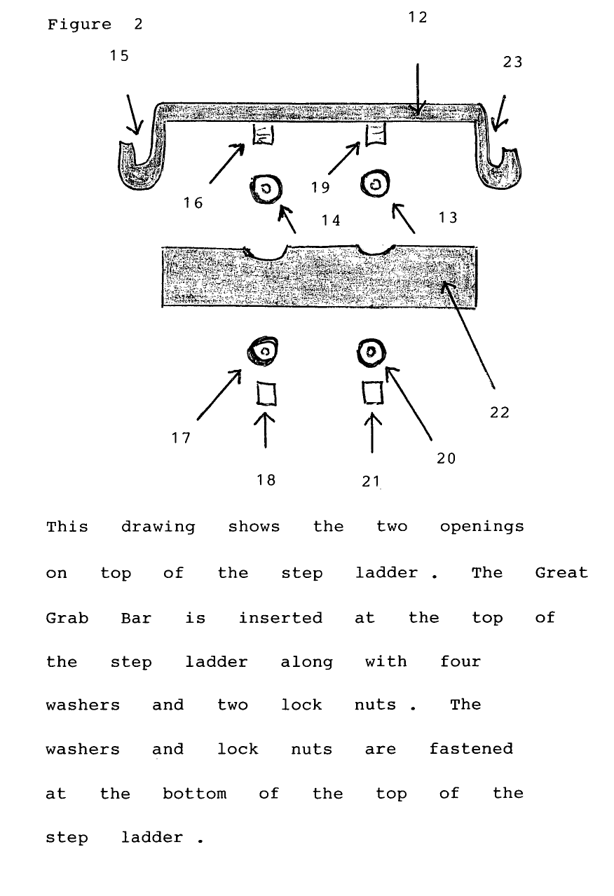

FIGS. 1 2 8a 8b 9 10a and 10b show the complete embodiment of the Great Grab Bar which I will show in the figures of drawings for the Specification.

In the closing statement of the Great Grab Bar it is a strong and helpful safe working tool.

The Great Grab Bar is made for industrial commercial and residential projects.

My main and only concern is the metal Great Grab Bar and nothing else.

Thank you John Smith inventor.

Figures of the drawings 1 through 10

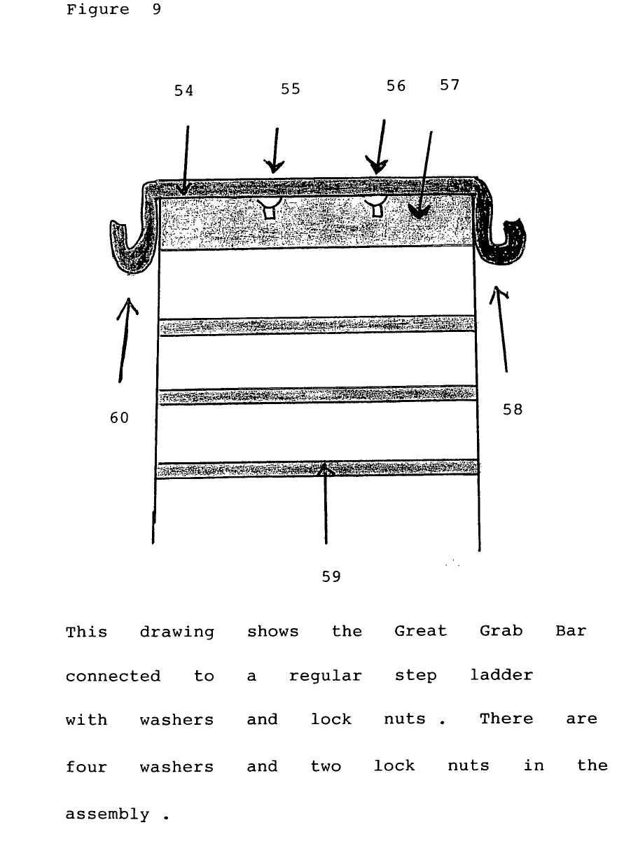

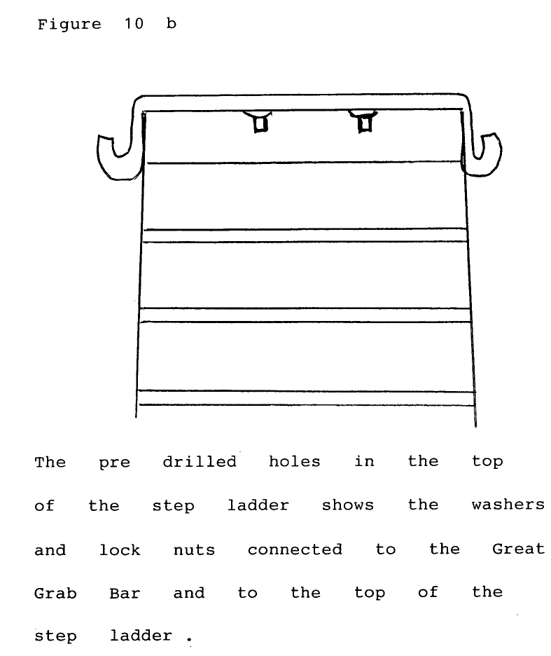

The following figures of the drawings are the concise information of the Great Grab Bar for the Specification. There is a and b on FIGS. 8 and 10.

FIG. 1 10

FIG. 1 shows all the parts needed to attach itself to a regular step ladder. It has two threaded bolts and two hooks stationed at each end they are all one piece. The four washers and two lock nuts aren t.

The two centered threaded bolts enter the top of the step ladder through two pre drilled holes on top of it.

The washers fit on top and bottom for a snug fitting with the lock nuts at the bottom of the top of the step ladder. The pre drilled holes are a tiny bit bigger than the centered threaded bolts. To make the bar fit real snug, a socket set should be used for fastening. When tightening you can feel how tight you want the Great Grab Bar to be.

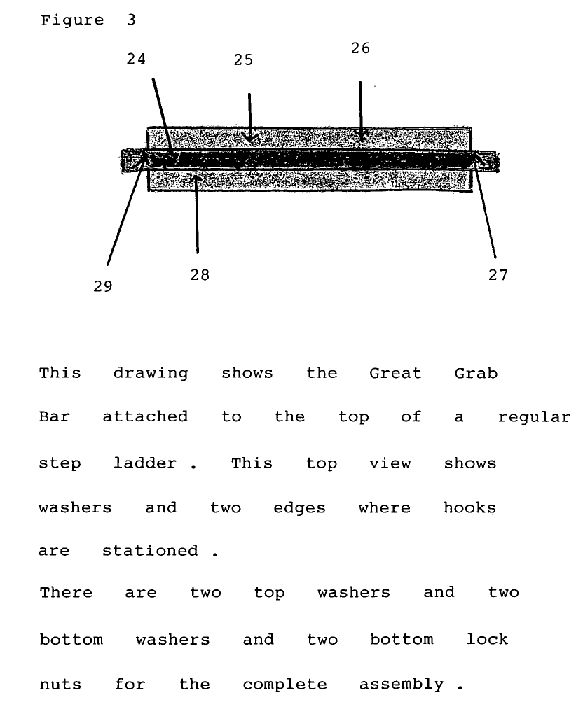

FIG. 2 10

FIG. 2 shows the Great Grab Bar with all it s parts ready to be attached to the top of a regular step ladder.

FIG. 3/10

FIG. 3 shows the top of the mounted Great Grab Bar to a regular step ladder FIG. 3 also shows the two left and right end hooks.

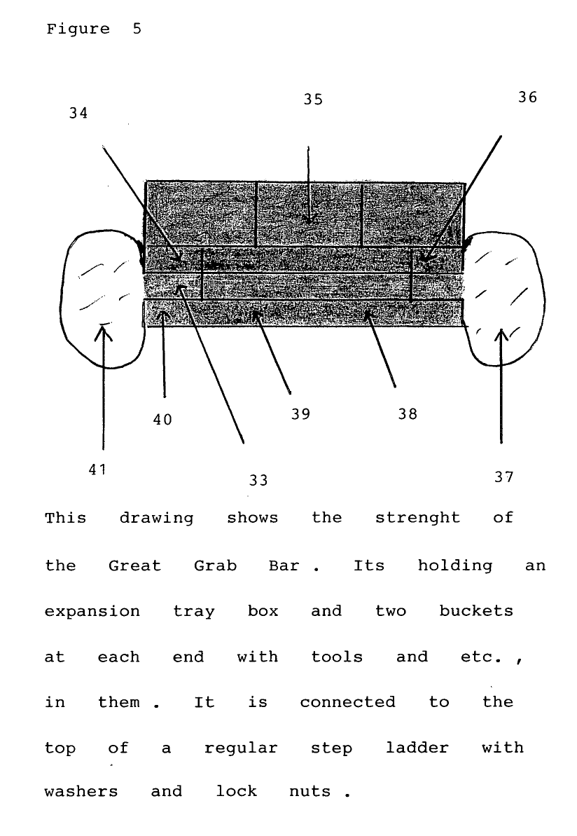

FIG. 4/10

FIG. 4 shows the bottom view of the washers and lock nuts that are fastened there preferably with a socket set.

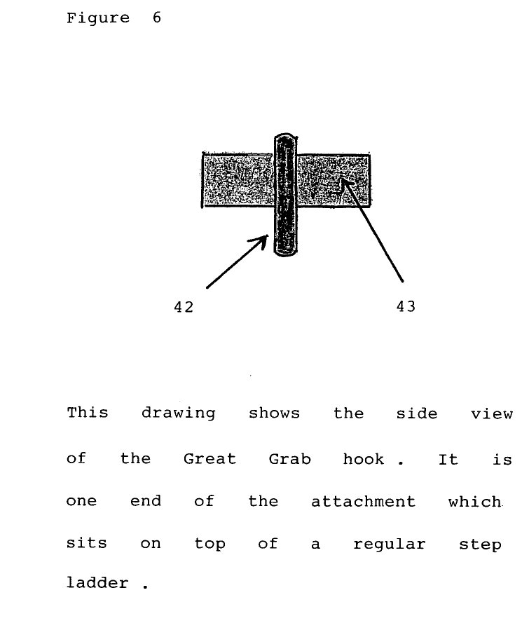

FIG. 5/10

FIG. 5 shows the top view of the Great Grab Bar sitting on top of a regular step ladder. It is holding two buckets and an expansion tray box.

The expansion tray box is held by two wires connected to the Great Grab Bar. Both the expansion tray box and the two buckets are doing their jobs by holding what is needed for the project.

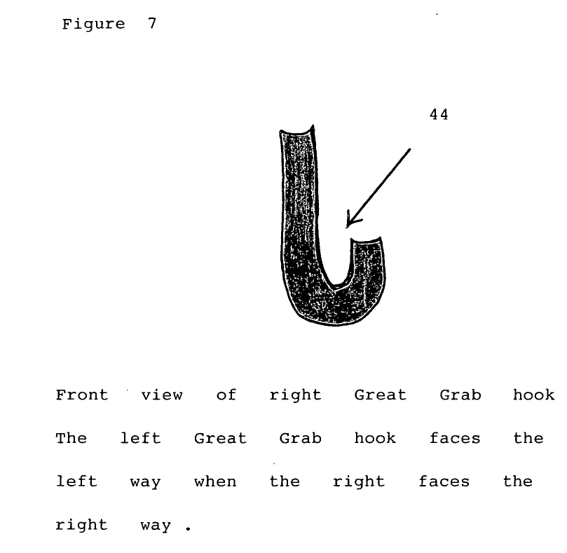

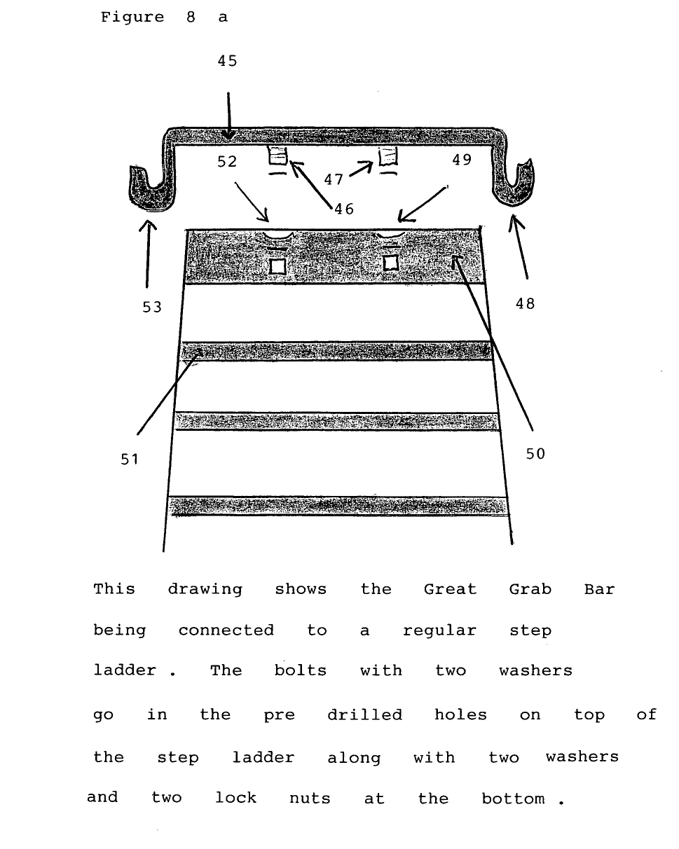

FIG. 6 10

FIG. 6 shows the side view of the Great Grab hook. It is placed on top of a regular step ladder.

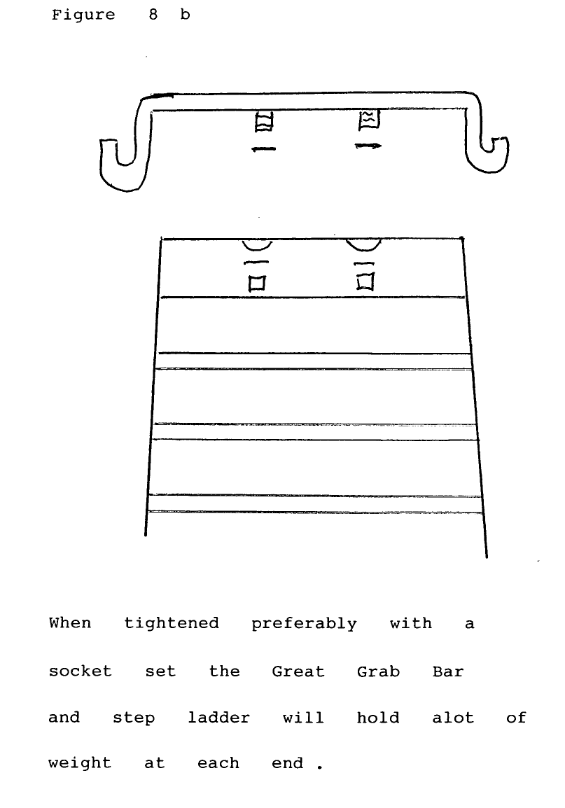

FIG. 7 10

FIG. 7 shows the front of the right hook and what it looks like facing you. The left hook on the other side of the Great Grab Bar faces left.

FIG. 8a/10

FIG. 8a shows the Great Grab Bar and its assembly ready to be inserted to a regular standard step ladder. The Great Grab Bar will go through the top of two pre drilled holes with two top washers. The Great Grab Bar will settle on top of the step ladder and be tightened with, the four washers and two lock nuts.

The four washers and two lock nuts will be connected by two centered threaded bolts, which will be fastened at the bottom of the top of the step ladder.

FIG. 8b/10

FIG. 8b shows the same as 8a but tells of how the Great Grab Bar can do its job.

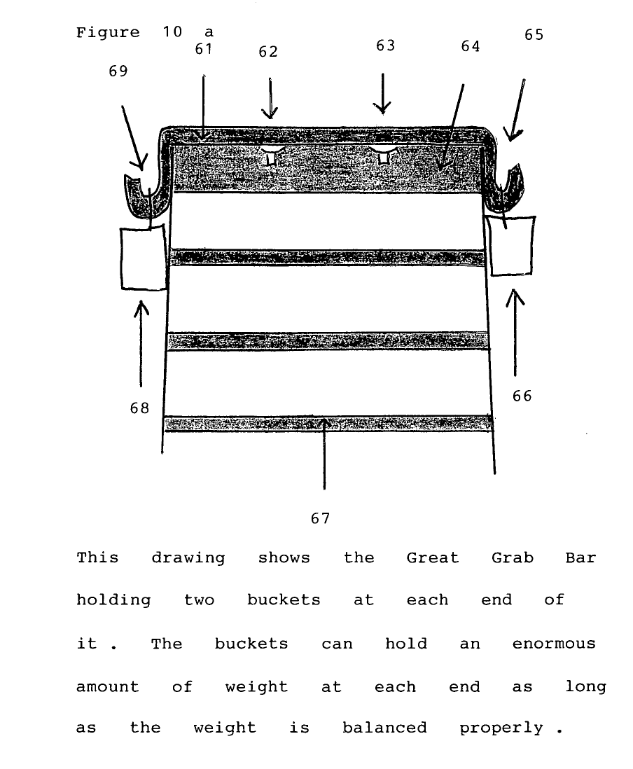

FIG. 9/10

FIG. 9 shows how the Great Grab Bar sits on top of a regular standard step ladder. It is mounted through the top of the step ladder, inserted through two pre drilled holes. If the top of the step ladder is made out of plastic or wood, pre drilling isn t difficult.

FIG. 10a/10

FIG. 10a shows two buckets one on the left side and one on the right side. The buckets are resting on the Great Grab Bars end hooks. This is what the Great Grab Bar is made for, to hold objects to do work projects safe and easy.

This figure also shows the importance of the tool, you do not have to go up and down a step ladder holding objects in your hands.

FIG. 10b/10

FIG. 10b shows in black and white how the Great Grab Bar is attached. FIG. 10b shows how the attachment is to the top of a regular standard step ladder with centered threaded bolts, washers, and lock nuts. They are fastened at the bottom of the top of the step ladder for a very safe work project.

I Claim that there are twelve figures of the Great Grab Bar drawings.

FIG. 8 has a and b and FIG. 10 has a and b also.

FIG. 1 of 12

This drawing shows all the assembly parts of the Great Grab Bar. The two left and right hooks and two threaded bolts centered are one piece of the Great Grab Bar. The washers and lock nuts are not.

FIG. 2 of 12

This drawing shows the Great Grab Bar ready to be attached to a top of a regular step ladder. The Great Bar is put through pre drilled holes at the top of it. All tops of regular step ladders are basically the same size in width and lenght.

FIG. 3 of 12

This drawing shows the top view of the Great Grab Bar mounted on the top of a regular step ladder. It has two edges left and right where the hooks are stationed. FIG. 3 also shows the two top washers.

FIG. 4 of 12

This drawing shows the connection at the bottom of a regular step ladder where the Great Grab Bar is tightened for safety with lock nuts.

FIG. 5 of 12

This drawing shows the Great Grab Bar holding two buckets one at each end and an expansion tray box. The expansion tray box sits in front of the Great Grab Bar held by two connecting wires to it.

FIG. 6 of 12

This drawing shows a side view of one hook setting on the top of a regular step ladder.

FIG. 7 of 12

This drawing shows the way the right hook looks when viewed at it.

FIG. 8a of 12

This drawing shows the pre drilled holes on top of a regular step ladder. It shows the Great Grab Bar ready to be mounted to it.

FIG. 8b of 12

This drawing shows what FIG. 8a states.

FIG. 9 of 12

This drawing shows the Great Grab Bar mounted to a regular step ladder.

It shows the lock nuts at the bottom of the top of the step ladder and what it looks like.

FIG. 10a of 12

This drawing shows a front view of the mounted Great Grab Bar with two regular buckets at the left end and the right end.

FIG. 10b of 12

This drawing shows the black and white version of FIG. 10a. It also shows the openings at the top of the step ladder with the tightened washers and lock nuts.

Big Johns Great Grab consists of a strong three eights inch piece of metal or made out of strong plastic across the top of a step ladder mounted to the top of the ladder. It is mounted through two holes on top of the ladder and tightened with washers and lock nuts. It is a bar with two hoops on the end of it to hold buckets or such to do a project with the ladder. two hoops

It also holds light trays in front of the ladder with thin metal holding the trays. The bar across the top of the ladder can be ajusted to hold another hook in front of the step ladder to hold another bucket in front of the step ladder. The other part of the kit is a three eights inch hook that holds on extension ladders.

This can also be made out of different metals or heavy plastics.

14 Fourteen Inches Across the step Ladder

3 8 Three Eights inch Thick

1 pd. One pound Metal Iron Weight

3 1 2 Three and one half inches down from edge of Ladder

1 1 2 One and one half inches from Curve on Bottom of Hook

1 1 2 One and a half inch Threaded Bolt

Total lenght before being bent is 29 inches

Total Weight is One Pound

These Dimensions are for the very Top of Step Ladders

14 Fourteen Inches in lenght in front of the top of the step Ladder the Tray is connected to the Great Grab with thin wires holding it

4 4 4 Four inches by four inches by four inches is the plastic Tray

4 ounces Four Ounces

1 1 6 One sixteenth inch Thick

Three separate openings in the Tray for light things such as nuts and bolts light bulbs etc.

Made out of Plastic for light step ladder work

1. What I claim as my invention is the Great Grab Bar is one solid piece of metal iron which sits on top of an ordinary step ladder. The Great Grab Bar is attached with washers and lock nuts to centered threaded bolts. The centered threaded bolts fit into pre drilled holes A lined at the top of a regular standard step ladder. The Great Grab Bar is perfectly balanced for safe work off of most any step ladders with a top attached to it.
The complete assembly of the Great Grab Bar are two centered threaded bolts two end hooks four washers and two lock nuts. The threaded bolts and hooks are all one piece of the bar. When installing the Great Grab Bar two washers are inserted with the centered threaded bolts through the pre drilled openings of the top of the step ladder. They are connected to two washers underneath the top of the step ladder and fastened with lock nuts at the bottom of the top of the step ladder.
Most step ladders have the same size tops in lenght and width for an easy and safe fit for the Great Grab Bar. The step ladder top is inter-locked to the Great Grab Bar with two washers and two lock nuts at the bottom.

2. What I claim as my invention is that not only can the Great Grab Bar be made out of metal it can also be made out of plastic. Metal is definitely the stronger of the two but plastic will do a great job also just for home use only.
The metal Great Grab Bar is made for all uses such as industrial commercial and residential projects. The plastic bar could only be used for residential work because it would be un safe out side home use. My main concern is just the metal Great Grab Bar nothing else it is made for all the work areas.

3. What I claim as my invention is that after the centered threaded bolts are attached at the bottom of the top of the step ladder the buckets or any hookable attachments will set safely at each hooked end. The metal Great Grab Bar has one hook on the left of it and one hook on the right of it for a safe great grab. The reason for the name of the Great Grab Bar is simple when something is hooked onto it, it acts as a great grab to the object and holds it perfect and safe.
To close I would like to say instead of running up and down a step ladder and being held off balance holding work objects in your hands, The Great Grab Bar has the objects safe and set.
